(19) United States
(12) Patent Application Publication
(10) Pub. No.: US 2016/0244188 A1
(43) Pub. Date: Aug. 25, 2016

(54) Trans-orbital freight and passenger carrier apparatuses supporting trans-orbital pipeline operations

(71) Applicant: John Aylmer, Winter Park, FL (US)

(72) Inventor: John Aylmer, Winter Park, FL (US)

(21) Appl. No.: 15/048,670

(22) Filed: Feb. 19, 2016

Related U.S. Application Data
(63) Continuation of application No. 14/998,419, filed on Jan. 2, 2016.

(51) Int. Cl. B64G 1/14; B64G 1/40; B64D 27/18; B64G 1/54

(52) U.S. Cl. CPC B64G 1/14; B64G 1/543; B64G 1/401; B64D 27/18

(57) ABSTRACT

This invention is pioneering a Strategic Trans-orbital Carrier (herein called ‘a carrier’) which merges the technologies attributes of a plurality commercial jet engines with a plurality reusable rocket engines to provide capabilities permitting a smooth computer-controlled transition from terrestrial air space to insertion into and thru low earth orbit (LEO) and into high geostationary earth orbit (GEO). A carrier would return back to terrestrial air space with carrying approximately 60 tons of any type of customers' defined cargo and passengers which would include intermodal container modules, complete DoD military strategic devices; heavy industrial outfitting apparatuses; building components for infrastructure complexes; personnel and robots; and space defensive materials to an in-situ space complex. With a fleet of carriers', a routine commercial services becomes available that are built to and guided by FAA flight regulations using specific airport with runways greater than 8,000 feet and that can handle a carriers weight.

### CROSS REFERENCE TO RELATED APPLICATIONS

This application claims are divisional and benefits of U.S. Provisional Application Ser. No. 62/175,253 filed on 12 Feb. 2015 and which is hereby incorporated by reference in its entirety; U.S. Provisional Application Ser. No. 62/176,512 filed on 20 Feb. 2015 and which is hereby incorporated by reference in its entirety; U.S. Provisional Application Ser. No. 62/282,148 filed on 16 Jul. 2015 and which is hereby incorporated by reference in its entirety;

### BACKGROUND OF THE INVENTION

This present invention introduces an improved strategic and operational transportation method focused on resolving the gaps identified by National Aeronautics and Space Administration (NASA), Defense Advanced Research Projects Agency (DARPA), USAF Nuclear Oversight Board (NOB) Air Force nuclear enterprise (NE), and the express desire of multiple American businesses to foster the growth of heavy commercialization and industrialization in space. The Carrier core mission is to establish a Transportation Logistics Pipeline FIG. 3 to support a continuous new construction in space FIG. 4, populate facilities, and then continuous 24/7/365 sustainment pipeline for all assets in operational space and planetary operations. An assortment of brilliant technologies does exist today, yet no one has defined a better uniformed for profit material solution to eliminate gaps neither to our military nor to the commercial business entities. This present invention introduces improvements to several material solutions to fulfill military and commercial gaps by blending several new technologies and components together into a robust freight and passenger trans-orbital carrier. At FIGS. 1, 2, a carrier design mirrors typical commercial airline operations flying under Federal Aviation Administration (FAA) flight rules and airport requirements (DOT/FAA/AR-97/26). Its flight envelope is computer-controlled, orchestrating a family of four terrestrial jet engines (equivalent to the GE90-115 series) and matched with the appropriate liquid methane/LOX rocket engines (equivalent to an enhanced Chase-10 series) which are capable of lifting and returning with approximately 60 tons cargo or 300 passengers to orbit. With this Carrier's extremely heavy lift commercial capabilities, it will include advanced thicker radiation and puncture-proof shielding that far exceeds the current materials used in the Orion reengineered 1962 space capsule.

With many parallel on-going efforts by plurality of government agencies and matched by a burgeoning commercial space flight industry, many without knowing are trying to resolve a needed DoD material solutions to overcome the current existing gaps and shortfalls for national security. The following paragraphs recite some government objectives from 2005 to 2013, which indicate that these material solutions with suitable apparatus are not realized and appear to be decades away.

In an 18 Oct. 2005 NASA Shuttle Report, NASA appears to lack a functional device adequate to accomplish the full spectrum of NASA-missions goals. Thus, such goals remain unsustainable because the space activities were constrained by the following:
Operational flexibility and responsiveness—flight rate has not achieved concept goals.
Operated by RDT&E personnel—the developer (instead of commercial operations personnel) with resultant high operations cost. There were no reward incentives, or system, to support order-of-magnitude cost cutting.
Limited in-space maneuvering capability—science and logistic mission scopes are not all-inclusive of agency vision.
Concern for safety and reliability is constrained to the system architecture—what you see is what you get.
Significant constraints on payload mass and volume. Greater operability (flight rate) is needed to reduce historical LCC ($/Per Load pounds to orbit/year) and provide much larger annual mass-throw capability; i.e., the learning curve.
Cancellation of the Space Shuttle Program with many of its tasks being subcontracted for example SPACE-X and other comparable companies.

As we move forward, the US Air Force Flight Plan has identified an array of different mission gaps to be satisfied. This invention presents an enabler technology that provides improved methods and apparatuses which facilitates continuous cargo daily delivery of tonnage to USAF and DoD orbital facilities (as cited in patent application 62/176,253). Within USAF Flight Plan for the Air Force Nuclear Enterprise, Vector 4 has defined gaps to establish and maintain an integrated, strategic approach to meet the Nation's needs for Air Force-provided deterrence and assurance capabilities. Although the carrier is a freight hauler, a carrier functional purpose is to delivery those military assets into orbit and/or return with assets to meet the USAF nuclear enterprise (NE) action plans and requirements. With the size and heavy lift capabilities of this carrier, the USAF NE staff is now able to evaluate and prioritize their requirements to a far greater extent in: (1) improving methods to sustain, modify and deploy new space weapons and intelligent systems; (2) constructing spacecraft debris collectors to capture and then return space junk (as cited in patent application 62/176,512); and providing a method of building and upgrading space complexes supporting—nuclear deterrence operations (NDO) or other Joint operations. A carrier would transport all military components needed to construct maintenance complexes (as cited in patent application 62/177,113); that would include: (1) DARPA weapon or research platforms; (2) finished goods storage areas; (3) living quarters; (4) maintenance and new assemblies; (5) fuel dumps; and (6) any defined future requirement to ensure that the infrastructure is capable of supporting any current or future mission. Once fielded and operational, a carrier further supports full implementation of all USAF strategic plans by having a Joint integrated and flexible investment budget line, sustainment, and recapitalization strategy to support nuclear deterrence and assurance requirements. Unlike current NASA rocket systems, an operational carrier does not dispose engines or rockets rather they remain on the craft and would enter a scheduled FAA anticipated ‘A’, ‘B’, ‘C’ flight checks and overhaul maintenance capitalizing on Commercial-Off-The-Shelf (COTS) components.

A carrier is an asset must be viewed as a logical evolution and continuous improvements in transportation logistics and the cornerstone an integral part of this inventors' family of systems of ever expanding series enabling technology and orbital and planetary facilities and infrastructure developments. This enabling technology concept permits others to design, build, outfit and ultimately transport an assortment of massive infrastructure complexes (as cited in patent application 62/177,113) based on specific requirements whether it is military, commercial, penal, resorts, heavy industrialization, or mining and refining business entities. These complexes would employ an unlimited use of robots and other related automated operations and/or networked together guided by human involvement.

As we examine the current recreation and business space industry, the FAA is establishing new regulations and policies for a fledgling industry which is developing a mixture of suborbital approaches (e.g. Virgin Galactic). The FAA has now classified these approaches as suborbital reusable vehicles (SRVs) which will pioneer a new spaceflight industry. SRVs are commercially developed reusable space vehicles that might carry a very limited amount of humans or cargo to very low earth orbit (LEO). The companies developing these vehicles typically target high flight rates and relatively low costs as compared to NASA or DOD launch. SRVs capable of carrying humans are in development, prototyping, and in the planning stage for commercial operations. Several of these SRV carriers have limited operational capabilities with funding provided by private investors who rightfully need to turn a quick profit. It here a carrier satisfies those gaps to transport customer's outfitting components need in the construction of their commercial space industry and mining environment Like any aircraft or spacecraft, a carrier will evolve and enable change to occur meeting future expanding operational needs. A builder of this carrier is encouraged to change components and systems as new technology insertions are developed to keep this method profitable and to expand its capabilities. It is this inventors' intent to offer this carrier as a commercial solution for business enterprises to jump start a trans-orbital transport service industry.

A recent FAA study forecasts a 10-year demand for suborbital reusable vehicles. The goal of their studies had been to provide information to government and industry decision makers on the emerging SRV market by analyzing market dynamics, especially areas of uncertainty and lack of awareness of SRV capabilities. The study was jointly funded by the Federal Aviation Administration Office of Commercial Space Transportation (FAA/AST) and Space Florida.

The expansion into space development is hindered by continued, growing military budget shortfalls while at the same time so many commercial enterprises have diverse spacecraft and approaches being explored. The entire fledging space industry lacks a singularity and will remain challenged for decades to get on the same page. Their collective desires lack a robust suitable material solution.

A carrier narrative below depicts a typical fight operation with some of the DoD material solutions or services it has been designed to perform:

While flying in the terrestrial common operating environment (COE), the Carrier embraces the heavy-lift flight envelope similar to an Airbus A380-F as it blends the fly-by wire commercial flight characteristics needed prior to insertion into low earth orbit. By using many of the B-787 or the Airbus A380-F functional characteristics and components, a carrier's flight profile is further enhanced with a USAF in-flight refueling system by a KC-135 permitting extended flight time when returning to a designated terrestrial landing strip. A returning carrier returns with an assortment of industrial cargo; personnel; classified tactical cargos; refined planetary minerals; and space junk or cargos designated by an owner/operator.

When the Carrier is flying within our terrestrial environment, it performs in an equivalent manner as a heavy cargo hauler (e.g. A380-F, B-787 or C-141) whether it is for the USAF Strategic Airlift Command or to be used by a common commercial Air Freight Company (E.g. FedEx, Virgin AIR or UPS). When the pilots arrive at the approximate altitude of approximately 45,000+ feet, a carriers' flight computer reconfigures the fuselage for insertion into space. As it reconfigures, a carrier ignites its family of cryogenic rocket engines 5 (e.g. a Chase-10) or an upgraded variant) which are managed by a orbital navigational computers until it reaches the Geostationary Earth Orbit (GEO) of approximately 62,200 kilometers to a in-situ space complex.

As recited earlier, a carrier primary function is a heavy freight hauler dually designed as trans-orbital service provider FIGS. 3, 4 and when configured performing similar to a commercial aircraft FIGS. 1, 2 supporting:
Commercial Orbital Transportation Services (COTS), by facilitating multiple DoD material solutions or commercial enterprises to expand any investors' or users capabilities to permit the routine delivery of an assortment of mass tonnage to rapidly grow heavy commercialization, penal, industrial and mining enterprises. This will further:
   Ignite a true U.S. Space Exploration Policy with an investment capital to stimulate commercial and mining enterprises in space,
   Facilitate U.S. private industry demonstration of improved cargo and crew space transportation capabilities with the goal of achieving reliable, cost effective access from Earth's orbit to planetary colonization, and
   Create a new market sector for manufacturing environment in which commercial space transportation services becomes available to the Government and private sector customers.
Intermodal Container Services enhances a carriers capability with a cargo bay of approximately 158,340 cubic feet. FIG. 3 illustrates how customized containers can be inserted into two floors of this cargo bay. These containers are custom built to meet customer requirements and permit utilization anywhere, including life support, living quarters, planetary habitation whether military, research, industry or commercial. Some containers will be designed for the delivery and maintenance of heavy construction equipment for planetary and asteroid mining enterprises. The usage is unlimited.
Space Federation Commercial Space Enabler Technology As an integral part of this inventions enabler technology, a carriers' primary function as a substantial cargo carrier underwrites the need for space federation to establish standards and policies for uniformed space operations and safety. It is this current patent to serve as a foundation of enabler technology permitting these complexes or spacecraft to be remotely fabricated in space orbit with standardized raw materials, systems and outfitting components delivered via this carrier.
Unlimited Services: A carrier simply is a truck to bring and return heavy cargo from orbiting space. Being a truck, the number of services is dependent on the utility desired and functional requirements are determined by its owner, operators and crew. The logistics pipeline threshold requirement is to lift and return with appropriately 60 tons to and from orbital space operating within FAA policies and procedures (as cited in patent application 62/176,253). A carriers' by design is a very large aircraft that is robust, heavily internally shielded, upgradable and reconfigurable, and has a strengthened fuselage. When reconfigured properly, a carrier can be used as a interplanetary transport until new spacecraft built in orbit become available (as cited in patent application 62/177,113).

### DRAWING DESCRIPTION

FIG. 1: is an isometric drawing of the “Type A” Trans-orbital Freight Carrier according to this invention.

FIG. 1A: is side, frontal and rear views and an isometric drawing showing the placement of the fuel cells and propulsion means of the “Type A” Trans-orbital Freight Carrier according to this invention.

FIG. 2: is an isometric drawing of the “Type B” Trans-orbital Passenger Carrier according to this invention.

FIG. 2A: is a side, frontal and rear views and an isometric drawing showing the placement of the fuel cells and propulsion means of the “Type B” Trans-orbital Passenger Carrier according to this invention.

FIG. 3: is a top view of the placement of a typical passenger intermodal container within any variant of a trans-orbital carrier according to this invention.

FIG. 3A: are a rear and isometric views of loaded intermodal containers and isometric view of a typical cargo manifest according to this invention.

FIG. 4: is a pictorial overview illustration of ground operations processing steps of a freight handler moving finished goods from a manufacturer to the loading and departure of a carrier into orbit according to this invention.

FIG. 5: is a pictorial overview illustration of orbital operations of off-loading cargo and performing its primary function according to this invention.

### DETAILED DESCRIPTION OF THE INVENTION

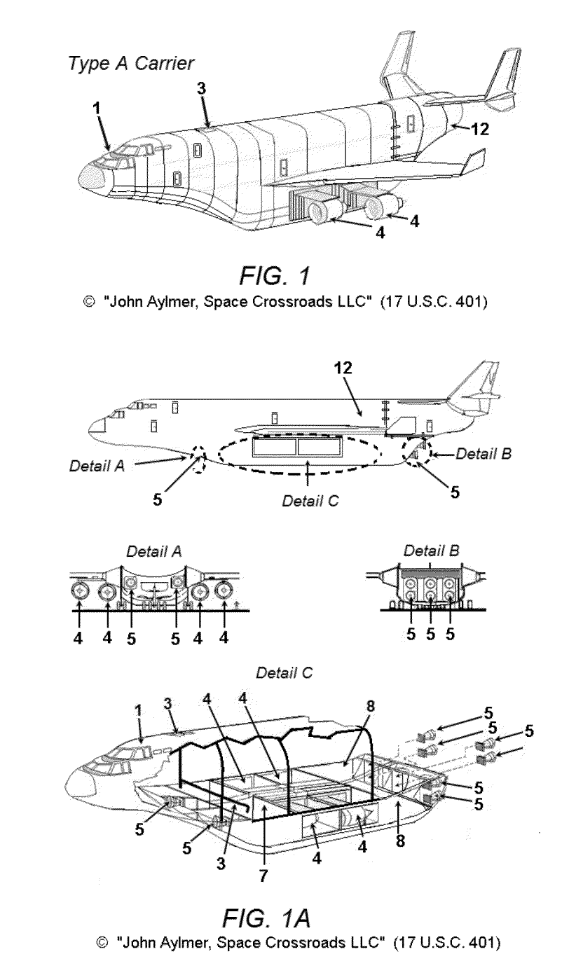

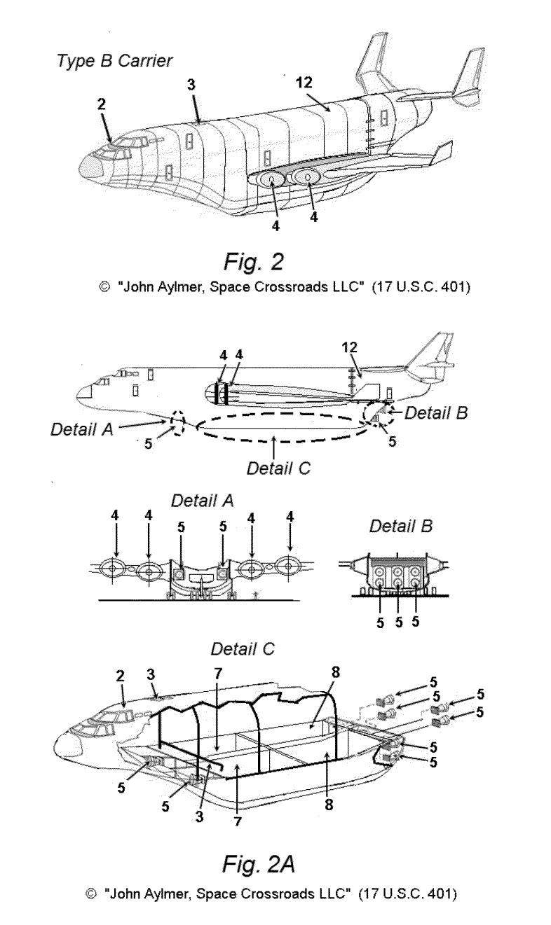

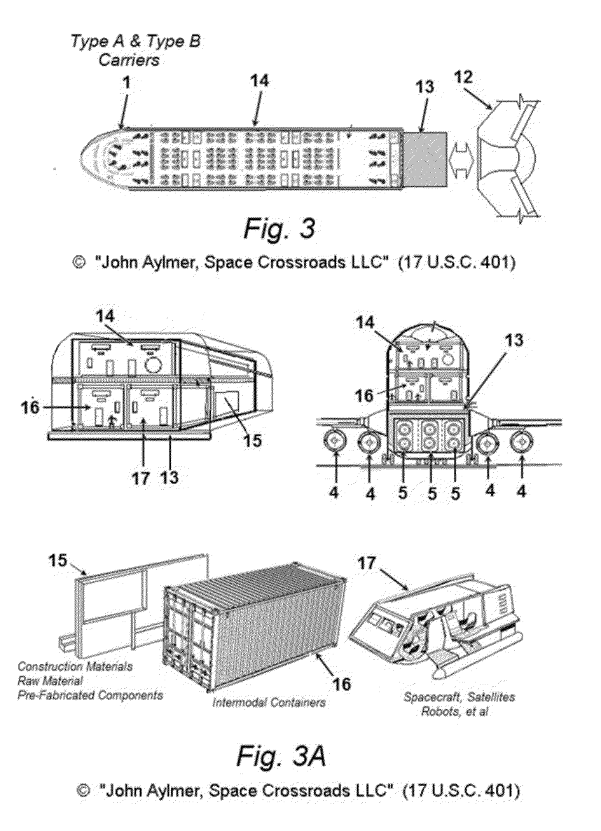

In this present invention, two variants of the trans-orbital freight and passenger carrier apparatuses are illustrated at FIG. 1 for Type A and FIG. 2 for the Type B (herein called a carrier). Both carrier variants share a high degree of systems and fuselage commonality, the major difference is the placement of the jet engines as to increase fuel capacity. Using the same functional characteristics of a Type B carrier, a Type C carrier is physically much smaller and dedicated to trans-orbital passenger service mirroring airliner operations and it internally reconfigured to light freight or mixture of both. These apparatuses primary function is to support the development of a trans-orbital heavy freight logistics and passenger service pipelines.

This present invention is an improvement over two currently used or in design apparatuses. The first apparatus uses a similar approach to fly a jet engine aircraft to a specific altitude then drop a secondary launch rocketed vehicle to near orbit. It mirrors the first Gemini orbit. Heavy freight operations are not achievable. The apparatus is in the engineering prototype stage using two jet engines that transitions in two rocket engines.

For this apparatus to perform the desired trans-orbital heavy-lift freight operations several related embodiments are needed. These embodiments are for planning, key structural design criteria needed for its mission profile, and understanding of a carriers intended “end state” mission purposes.

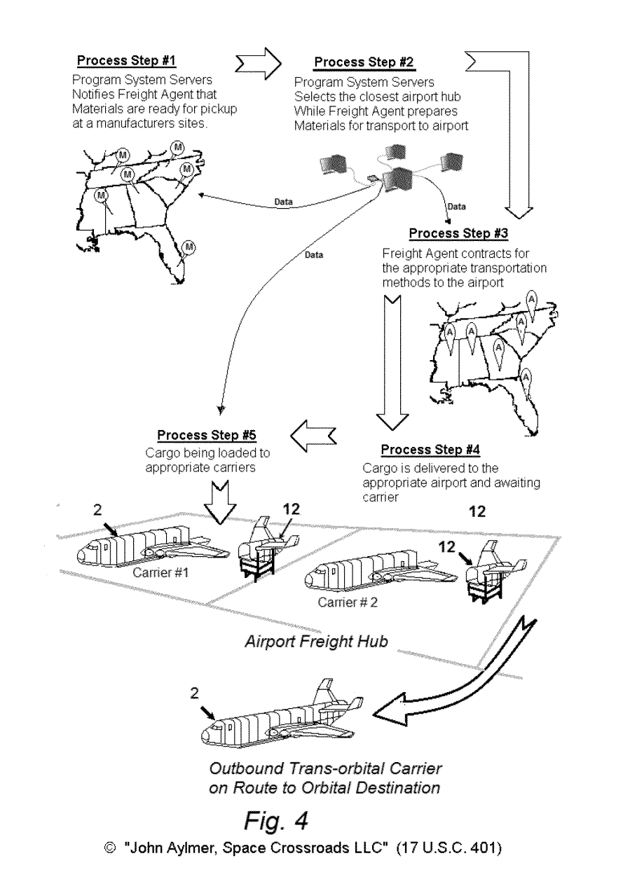

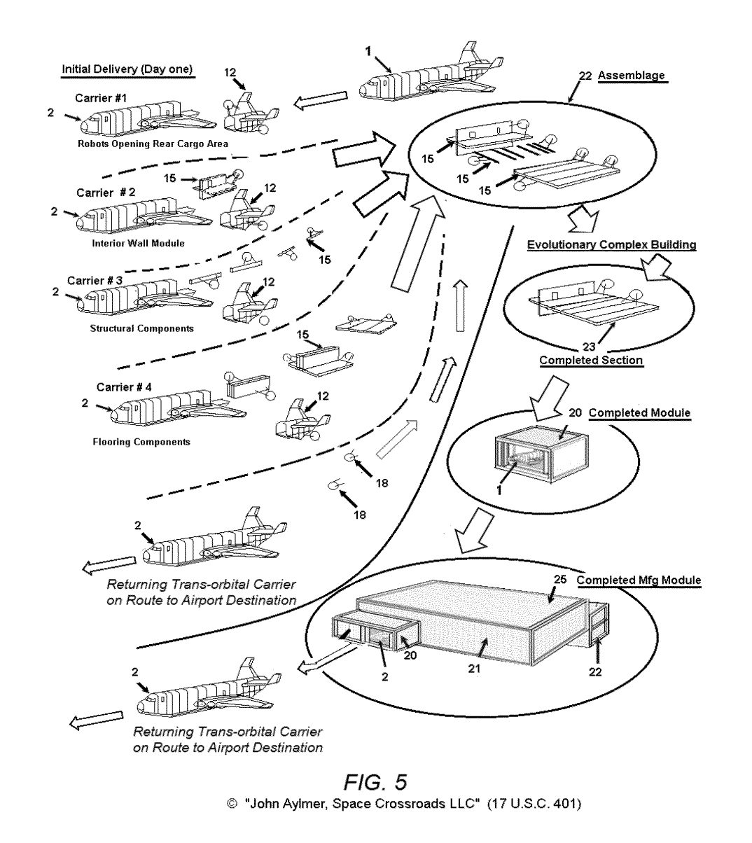

In the first embodiment, a carrier flight plan criteria is to fly under the plurality of FAA general aviation and commercial division and its related branches regulations and guidelines. By following the FAA regulations, a carrier will be permitted fly in terrestrial airspace and transition for rapid insertion into orbital space FIG. 4 and its controlled return back into terrestrial airspace for landing at specific approved runways (as cited in patent application 62/176,253). Carrier flight characteristics are managed by flight, space communication and navigation (SCaN) computers that orchestrate a reconfiguration of the Carrier terrestrial structure into a cleaner trans-orbital structure for smooth and safe insertion into geo-synchronous earth orbit to deliver cargo and passengers to a specific orbital in-situ location FIG. 5. At the appropriate altitude where the jet engines can engage, a carrier is reconfigured back into a terrestrial aircraft, designed to land a specific airports to meet DOT/FAA/AR-97/26 regulations, that is capable of landing at predestinated landing strip to deliver cargo and passengers.

Under the second embodiment, a carrier has infused two distinctive engineering concepts of employing a commercially sustainable and available jet engine technology 4, 11 (e.g. GE90-115) and the small set of commercially sustainable and available set of rocket engines 5 (e.g. Chase-10). With two different engines types, the carrier requires two separate fuel cells for standard jet fuel 3, and two cells 8 for one cell stores liquid methane and the second stores Liquid Hydrogen (LH2) respectfully. A set of four jet engine set will achieve an attitude about approximately 45,000 feet and when at appropriate altitude the flight computer ignites six rocket engines affording an additional output of 150,000 pounds of rocket thrust to bring a carrier into geostationary transfer orbit (GTO) of appropriately 26,000 miles. Once passed the GTO, the fight computer throttles back to rocket engines going into the in-situ geosynchronous earth orbit (GEO) apogee and commence breaking before arriving at specified construction site 20 or later repurposed to a freight hub 21 locations FIG. 5, appropriately 85,000 miles from earth.

The third embodiment of a carrier is it that functions as a truck. A carrier (or truck) is capable lifting afloat and landing at a specific airport with approximately 60 tons of cargo within its cargo area approximately 158,000 cubic feet. The cargo area provides for any combination of open cargo 15, space craft or satellites 17 and any type of intermodal containers 16. A part of this embodiment is the extreme width of a carrier. A carrier width is a critical design element because the open space provides for the transport of an assortment large building panels, structural beams and even wall and flooring completed modular sections to rapidly construct massive facilities, spacecraft and other infrastructures. A prime advantage of passenger intermodals it is engineered to be directly plugged into space facility so passengers are not performing a spacewalk. Simply, it would mimic the way passenger now disembark at a typical airport

Having described in the embodiments of this invention, the claims are:

1. An trans-orbital carrier aircraft comprising of two partitions with said upper partition used by the flight crew and cargo while the said lower partition will house two different propulsion systems, two different fuel systems, hydraulic systems and a robust landing gear systems providing a method to lift approximately 60 tons cargo aloft for insertion into orbital space with the capability to return to earth for a controlled safe landing to an assigned air strips.

2. Method of claim 1 wherein is to achieve the said insertion and return from orbital space is directly managed by an integration of flight, space communication and navigation flight computers orchestrating the physical reconfiguration from a terrestrial airframe structure into a cleaner aerodynamic structure that will withstand the extreme trans-orbital flight conditions.

3. Method of claim 2 wherein is a mechanisms orchestrated by said flight computers that operate the nacelles clam shell protective covers protecting the jet engines mounted within the wings

4. Method of claim 1 wherein is a carrier is capable of said fuel replenishment using standard in-flight refueling (IFR) methods to extend a carriers range to land at assigned air strips.

5. Method of claim 1 wherein a array of an assortment of types of bulk and palletized cargo of approximately 60 tons that can be rolled into position and/or locked down in the said cargo area for trans-orbital flights.

6. Method of claim 1 wherein a carrier provides said capability to load and secure any standard or custom intermodal containers

7. Method of claim 6 wherein said intermodal containers can be placed on either the first and/or second floor level of a freight carrier.

8. Method of claim 6 wherein carries intermodal containers and all other assortment of cargo to be loaded and unloaded from the rear of a carrier.

9. Method of claim 2 wherein a carriers' internal structural walls provides the maximum about of radiation protection and other types and levels of human protection from the space environment regardless of mission duration and destination.

10. Method of claim 1 wherein a carrier is capable performing under FAA policy and procedures for commercial airline flight operations flying under the appropriate weather flight conditions whether landing or takeoff from approved runways.

11. Method of claim 1 wherein a carrier is capable of being fully maintained in orbit whether by robot and/or humans.
